(19) United States
(12) Patent Application Publication
(10) Pub. No.: US 2015/0334191 A1
(43) Pub. Date: Nov. 19, 2015

(54) METHOD AND DEVICE FOR TRANSMITTING IMAGE

(71) Applicant: Xiaomi Inc., Beijing (CN)

(72) Inventors: Wei Wang, Beijing (CN); Peng Sun, Beijing (CN); Quanguo Zhao, Beijing (CN)

(21) Appl. No.: 14/585,207

(22) Filed: Dec. 30, 2014

Related U.S. Application Data
(63) Continuation of application No. PCT/CN2014/089320, filed on Oct. 23, 2014.

(30) Foreign Application Priority Data
May 14, 2014 (CN) 201410203570.0

(51) Int. Cl. H04L 29/08; G06F 17/30; H04L 29/12; H04L 29/06

(52) U.S. Cl. CPC H04L 67/141; H04L 65/60; G06F 17/30153; H04L 61/2007

(57) ABSTRACT

The present disclosure relates to a method and a device for transmitting images. The method includes: receiving an IP connection request sent from a computer; acquiring an IP address of the computer according to the received IP connection request; acquiring screenshots and direction information related to the screenshots; and sending the screenshots and the direction information to the computer via IP Layer according to the IP address. In addition to screenshots, the embodiment also transmits the direction information related to the screenshots so that a receiving end may display better screenshots according to the direction information, thus improving the display effect.

### CROSS-REFERENCE TO RELATED APPLICATIONS

This application is a Continuation Application of International Application No. PCT/CN2014/089320, filed on Oct. 23, 2014, which is based upon and claims priority to Chinese Patent Application No. 201410203570.0, filed on May 14, 2014, the entire contents of which are incorporated herein by reference.

### TECHNICAL FIELD

The present disclosure generally relates to the field of computer processing, and more particularly, to a method and a device for transmitting images.

### BACKGROUND

With the development of electronic technology, more and more terminal devices provide people with various services, such as entertainment services, information search services and interactive services, etc. The terminal devices may include a mobile phone, a computer and a TV set, and etc. In related technologies, connection and communication between a mobile phone and a computer, a mobile phone and a TV set, and a computer and a TV set are available.

### SUMMARY

According to a first aspect of the embodiment in the present disclosure, there is provided a method for transmitting images, comprising: receiving an IP connection request sent from a computer; acquiring an IP address of the computer according to the received IP connection request; acquiring screenshots and direction information related to the screenshots; and sending the screenshots and the direction information to the computer via IP Layer according to the IP address.

According to a second aspect of the embodiment of the present disclosure, there is provided a method for receiving images, comprising: sending an IP connection request to a terminal device according to an IP address of the terminal device stored locally; receiving screenshots and direction information related to the screenshots sent from the terminal device via IP Layer; and displaying the screenshots according to the direction information.

According to a third aspect of the embodiments of the disclosure, a device for transmitting images is provided. The device includes a processor; a memory configured to store instruction executable by the processor; wherein the processor is configured to perform: receiving an IP connection request sent from a computer; acquiring an IP address of the computer according to the received IP connection request; acquiring screenshots and direction information related to the screenshots; and sending the screenshots and the direction information to the computer via IP Layer according to the IP address.

According to a fourth aspect of the embodiments of the present disclosure, a device for receiving images is provided. The device includes a processor; a memory configured to store instruction executable by the processor; wherein the processor is configured to perform: sending an IP connection request to a terminal device according to an IP address of the terminal device stored locally; receiving screenshots and direction information related to the screenshots sent from the terminal device via IP Layer; and displaying the screenshots according to the direction information.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of displaying screenshots according to an exemplary embodiment.

FIG. 2 is a schematic diagram of displaying screenshots according to an exemplary embodiment.

FIG. 3 is a schematic diagram of displaying screenshots according to an exemplary embodiment.

FIG. 4 is a flow chart showing a method for transmitting images according to an exemplary embodiment.

FIG. 5 is a schematic diagram showing a direction of a terminal device according to an exemplary embodiment.

FIG. 6 is a schematic diagram showing a direction of a terminal device according to an exemplary embodiment.

FIG. 7 is a flow chart showing a connection process method according to an exemplary embodiment.

FIG. 8 is a flow chart showing a method for receiving images according to an exemplary embodiment.

FIG. 9 is a flow chart showing a method for transmitting and receiving images according to an exemplary embodiment.

FIG. 10 is a schematic diagram of displaying screenshots according to an exemplary embodiment.

FIG. 11 is a flow chart showing a method for transmitting and receiving images according to another exemplary embodiment.

FIG. 12 is a block diagram of an apparatus for transmitting images according to an exemplary embodiment.

FIG. 13 is a block diagram of an acquisition module according to an exemplary embodiment.

FIG. 14 is a block diagram of an apparatus for transmitting images according to another exemplary embodiment.

FIG. 15 is a block diagram of an apparatus for transmitting images according to another exemplary embodiment.

FIG. 16 is a block diagram of an apparatus for receiving images according to an exemplary embodiment.

FIG. 17 is a block diagram of a device for transmitting images according to an exemplary embodiment.

FIG. 18 is a block diagram of a device for receiving images according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

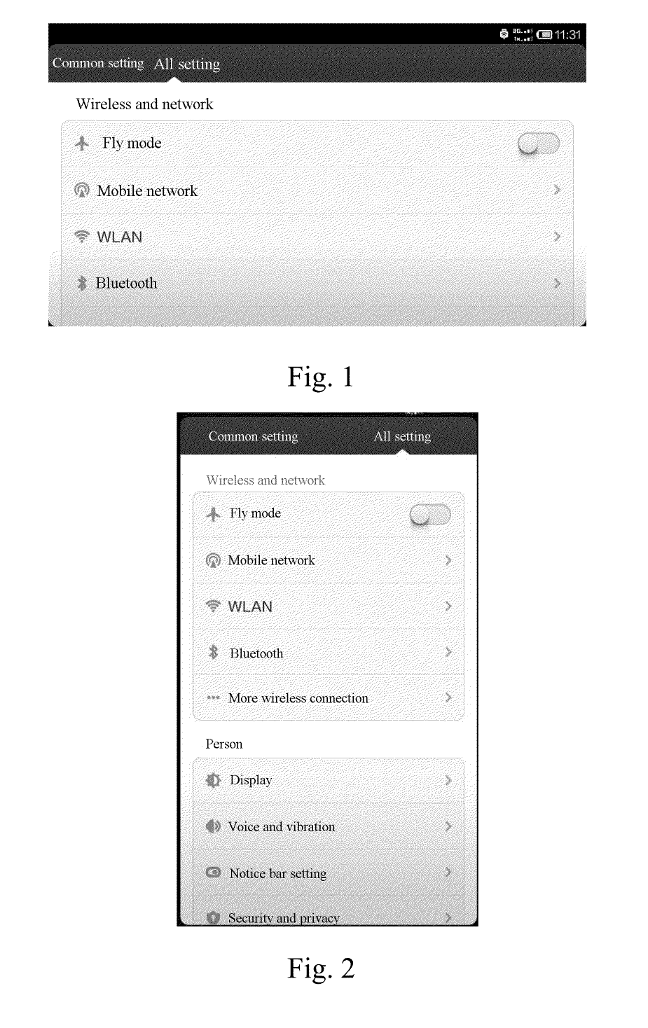

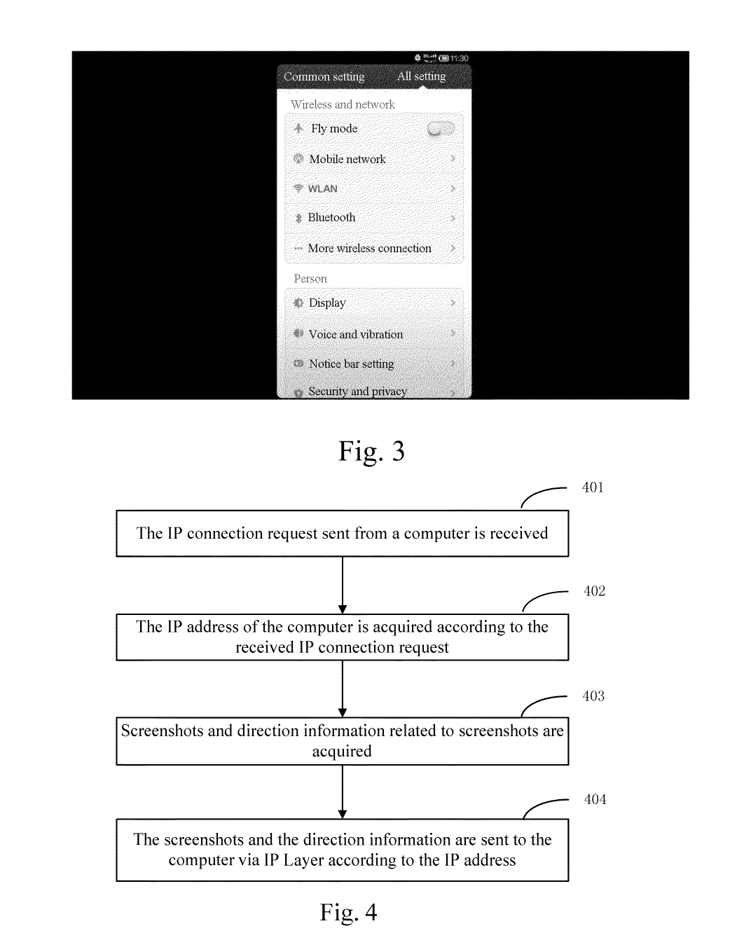

A screen display mode is subject to automatic adjustment by a terminal device on the basis of its own direction, for example, landscape mode or vertical mode. For example, screenshots displayed by the terminal device in the landscape mode is shown in FIG. 1, and screenshots displayed in the vertical mode is shown in FIG. 2. It may be known from FIG. 1 and FIG. 2 that, the length-width ratio of the screenshots is different in the landscape mode and the vertical mode. However, display window of a majority of computers has a display scale of 16:9. When the screenshots as shown in FIG. 1 and FIG. 2 are received by a computer and displayed in a display window with the display scale of 16:9, the display effect of the screenshots in the landscape mode is basically the same as shown in FIG. 1, and the display effect of the screenshots in the vertical mode is as shown in FIG. 3. It may be known from FIG. 3 that, the screenshots are obviously zoomed out, with a poor resolution. The screenshots need zooming in for a clear display. In the embodiments of the present disclosure, in addition to the screenshots, the terminal device also transmits direction information related to the screenshots, thus increasing the amount of transmitted information and providing reference information for display by the computer end. The computer may adaptively display the screenshots according to the direction information, thus improving the display effect.

FIG. 4 is a flow chart showing a method for transmitting images according to an exemplary embodiment. As shown in FIG. 4, the method may be performed by the terminal device (such as a mobile phone), and includes the following steps.

In Step 401, the IP connection request sent from a computer is received.

In Step 402, the IP address of the computer is acquired according to the received IP connection request.

In Step 403, screenshots and direction information related to the screenshots are acquired.

In Step 404, both the screenshots and the direction information are sent to the computer via IP Layer according to the IP address.

In the embodiment, in addition to the screenshots, the terminal device also acquires and transmits the direction information related to the screenshots. The objective is to provide the direction information to the computer at the opposite end so that the computer may display better screenshots according to the direction information and thus solving the problem of poor display effect of pictures caused by the landscape mode or the vertical mode of the terminal device. Besides, the terminal device may acquire the IP address of the computer at one stroke by receiving the IP connection request so as to realize subsequent transmission of the screenshots, thus simplifying the IP connection process and improving efficiency.

The terminal device may be connected to the computer via a USB (Universal Serial Bus), or through wireless connection including WiFi (Wireless Fidelity) connection, Bluetooth connection and NFC (Near Field Communication) connection, etc. In related technologies, information transmission between the terminal device and the computer is realized by the aforementioned connections. However, all the aforementioned connections pertain to physical layer connection, which have poor compatibility. The embodiment employs IP Layer Communication so that various connection modes are applicable to transmitting the screenshots. This is because transmission of screenshots by means of IP Layer may be compatible with various physical connection modes.

The terminal device in the embodiment may be an electronic device that may automatically rotate screen, for example, a mobile phone or a tablet computer and the like. The computer may be an electronic device that may not automatically rotate screen, for example, a laptop, a desktop computer or an all-in-one desk computer and the like.

In Step 403, there are many implementations for acquiring the direction information related to the screenshots, for example, implementations A1-A3.

In implementation A1, the terminal device may mark a current screen direction by using a special status identification and store the status identification in a preset storage location. In the embodiment, the status identification may serve as the direction information related to the screenshots. Therefore it is possible to read the direction information from a locally preset storage location for storing the direction information related to the screenshots.

In implementation A2, as shown in FIG. 1, the length-width ratio of the screenshots in the landscape mode is 16:9, where a length being greater than a width. As shown in FIG. 2, the length-width ratio of the screenshots in the vertical mode is 9:16, the length being smaller than the width. Therefore, the screenshots may be determined as screenshots in the landscape mode if the length is greater than the width; and the screenshots may be determined as screenshots in the vertical mode if the length is smaller than the width. Therefore, the direction information related to the screenshots may be determined according to the length-width ratio of the screenshots.

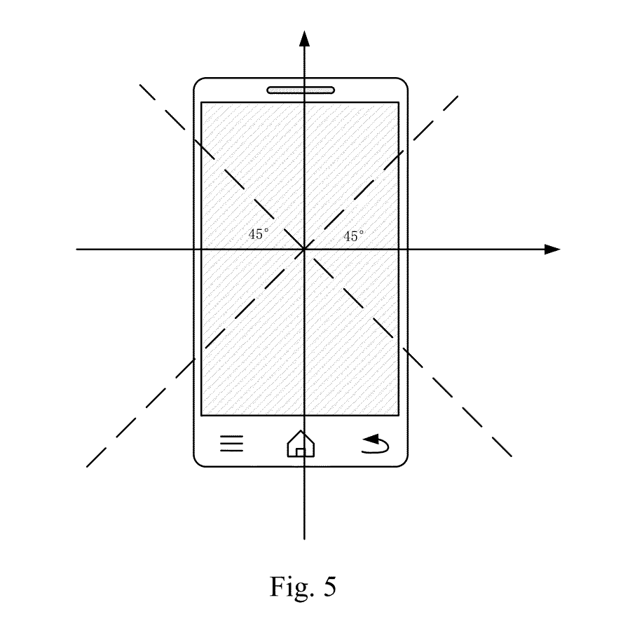

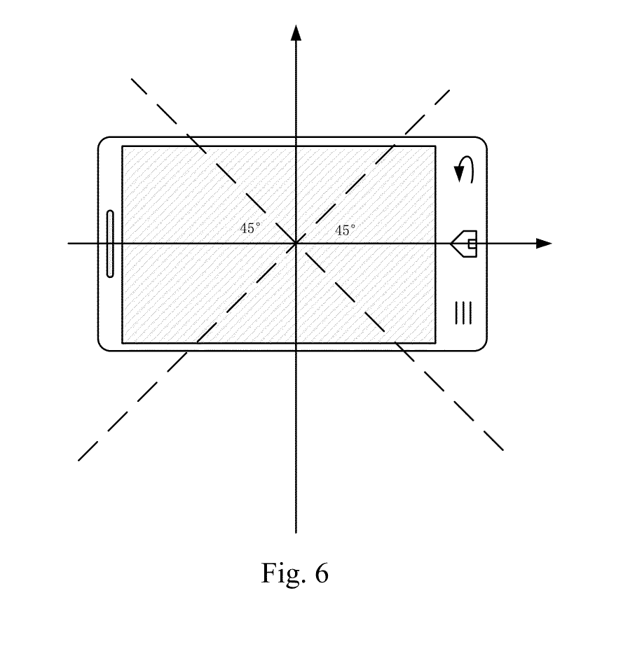

In implementation A3, the terminal device may detect autorotation via a local direction sensor and automatically rotates the screen. Therefore, the terminal device may orient the current direction via the local direction sensor, and may determine the landscape mode or the vertical mode according to the direction information from the direction sensor. Therefore, the direction information related to the screenshots may be determined according to the direction information determined by the local direction sensor. For example, refer to FIG. 5 and FIG. 6. The landscape mode is employed if the direction of the terminal device is at [0, 45], [125, 225] or [315, 360], and the direction information related to the screenshots is determined as direction information representing the landscape mode; the vertical mode is employed if the direction of the terminal device is at (45, 125) or (225, 315), and the direction information related to the screenshots is determined as direction information representing the vertical mode.

The direction information in the embodiment includes the direction information representing the landscape mode and direction information representing the vertical mode, and may have many patterns of manifestation. For example, “0” is configured to represent direction information of the landscape mode, while “1” is configured to represent direction information of the vertical mode.

In Step 403, the process of acquiring the screenshots may have different implementations on the basis of different application scenarios, for example, implementation B1 and implementation B2.

In implementation B1, screen capturing is performed and screenshots are acquired while receiving the screenshots and transmission instructions. Thereafter, the acquired screenshots are sent. This implementation may be applicable to acquiring and transmitting a constant screenshot.

In implementation B2, screen capturing to the interface of the terminal device is performed and screenshots are acquired, the acquired screenshots are stored into a framebuffer and the screenshots are acquired from the framebuffer. This implementation may be applicable to real-time dual screen synchronization. After receiving a synchronous command, screen capture is continuously conducted; the screenshots acquired are immediately stored into the framebuffer; then the screenshots are read out of the framebuffer and sent, thus mitigating the problem of asynchronism of screen capturing and screenshots sending. The screenshots should be deleted from the framebuffer once being sent out so as to continue storing new screenshots.

The screenshots are compressed for improving the transmission efficiency and the screenshots acquired are the compressed screenshots. The compressed screenshots and the direction information are sent to the computer via IP Layer.

In Step 401, the process of establishing IP connection is simplified by means of receiving IP connection request (equivalent to establishing IP connection) by the terminal device. For the convenience of transmitting the screenshots, the embodiment may employ Session Protocol for transmission. Therefore, the IP connection request is a RTSP (Real Time Streaming Protocol) session connection request based on IP Layer, and the RTSP session connection request includes a UDP port number for transmitting the screenshots. An introduction of RTSP session connection process is made in detail hereinafter.

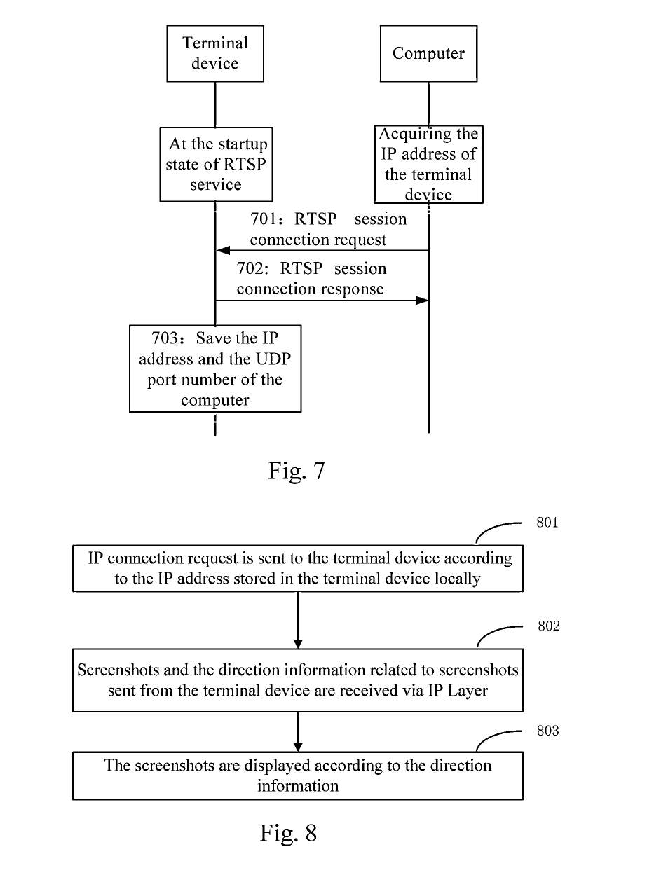

The terminal device is at the startup state of RTSP service. Take computer initiation connection as an example, referring to FIG. 7. The computer acquires in advance the IP address of the terminal device, for example, the IP address of the terminal device may be acquired by way of USB connection and WiFi scanning, etc.

In Step 701, the computer sends the RTSP session connection request to the terminal device according to the IP address of the terminal device, wherein the RTSP session connection request includes the IP address and the UDP port number of the computer, and the UDP port number is used for transmitting the screenshots.

In Step 702, the terminal device sends the RTSP session connection response to the computer. Parameter negotiation is made with the computer via RTSP session connection response, which is equivalent to merging response process with parameter negotiation process, thus further simplifying the connection process.

In Step 703, the terminal device saves the IP address and the UDP port number of the computer for the convenience of transmitting the screenshots in a later process.

After the connection process as shown in FIG. 7, in Step 404, the screenshots and the direction information are sent to the computer with the IP address and the UDP port number via the RTSP session of the IP Layer.

Network may be disconnected after a connection between the terminal device and the computer is established. Network disconnection may happen in the following two cases. In Case 1, abnormal disconnection occurs, which resulted from terminal device fault or computer fault, etc. In Case 2, normal disconnection occurs, for example, the terminal device sends disconnection message or halt message (or stop message) to the computer, and the computer will disconnect the network after receiving the disconnection message or halt message.

The process of transmitting the screenshots is introduced hereinabove from the perspective of the terminal device, with the receiving end of the screenshots being the computer. A process of transmission of screenshots is introduced hereinafter from the perspective of the computer.

FIG. 8 is a flow chart showing a method for receiving images according to an exemplary embodiment. As shown in FIG. 8, the method may be performed by a computer, and includes the following steps.

In Step 801, an IP connection request is sent to a terminal device according to an IP address stored in the terminal device locally.

In Step 802, screenshots and direction information related to the screenshots sent from the terminal device are received via IP Layer.

In Step 803, the screenshots are displayed according to the direction information.

In the embodiment, in addition to the screenshots, the computer also receives the direction information related to the screenshots, thus increasing the amount of received information. The computer may display better screenshots according to the received direction information, thus improving the display effect. In addition, the computer receives the screenshots and the direction information via the IP Layer, which is compatible with various physical connections, not restricted by physical connection types.

In Step 803, there are many implementations for displaying the screenshots according to the direction information, for example, implementations C1 and C2.

In implementation C1, a display screen of the computer generally has a display scale of 16:9, accordingly a display window generally being 16:9. This type of display window is more suitable for displaying the screenshots in a landscape mode. Therefore, the screenshots may be directly displayed if they are determined as ones in the landscape mode according to the direction information. The screenshots may be zoomed in according to a length of the display window if they are determined as ones in a vertical mode according to direction information.

In implementation C2, the computer controls the scale and size of a window for displaying the screenshots according to the direction information, and displays the screenshots through the window. In implementation C2, neither the scale nor the size of the display window is fixed, and adjustment of both is available according to the screenshots. For example, the display window has the display scale of 16:9 if the screenshots are determined as ones in the landscape mode according to the direction information, and the size of the display window may be adjusted according to the resolution of the screenshots. The display window has a display scale of 9:16 if the screenshots are determined as ones in the vertical mode according to the direction information, and the size of the display window may be adjusted according to the resolution of the screenshots.

In Step 801, the IP address of the terminal device is stored in the computer. For example, the computer is installed with an application of “Mobile Phone Helper”, through which the IP address of the terminal device may be acquired, no addressing process is required. The computer may directly send the IP connection request to the terminal device according to the IP address stored. For the convenience of transmitting the screenshots, the IP connection request is a RTSP session connection request based on the IP Layer, and the RTSP session connection request includes a UDP port number for transmission of the screenshots. The connection process is referred to the foregoing introduction, not elaborated herein. In Step 802, by way of the RTSP session of the IP Layer, both the screenshots and the direction information related to the screenshots sent from the terminal device are received on the UDP port number.

It may be known from what is introduced hereinabove that, there may be multiple implementations in a plurality of links for transmission of screenshots, and these implementations will be referred to in detail hereinafter by a plurality of embodiments.

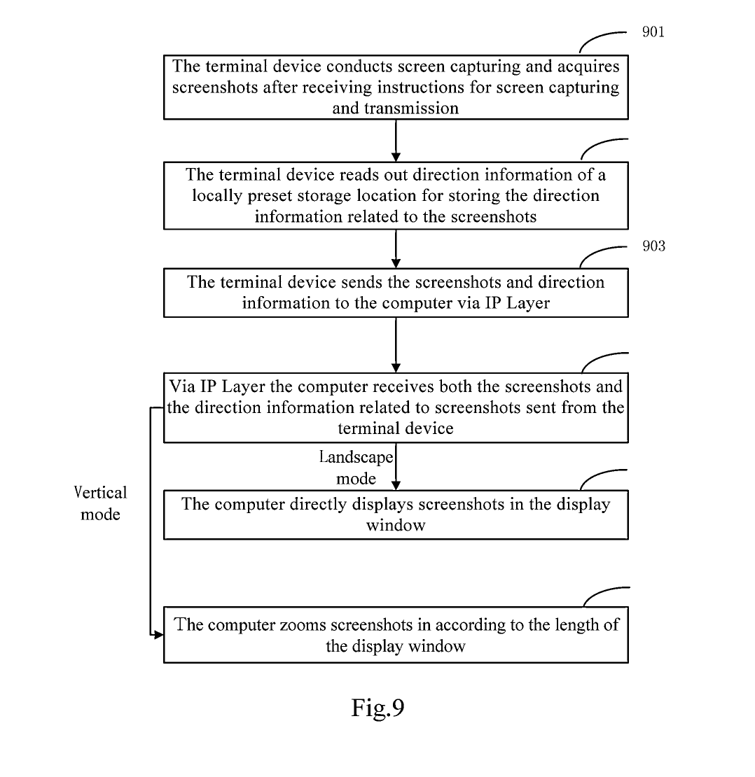

FIG. 9 is a flow chart showing a method for transmitting and receiving images according to an exemplary embodiment. As shown in FIG. 9, the method includes the following steps.

In Step 901, a terminal device conducts screen capturing and acquires screenshots after receiving instructions for screen capturing and transmission.

In Step 902, the terminal device reads out direction information of a locally preset storage location for storing the direction information related to the screenshots.

In Step 903, the terminal device sends the screenshots and the direction information to a computer via IP Layer.

In Step 904, via IP Layer, the computer receives both the screenshots and the direction information related to the screenshots sent from the terminal device. Proceed to Step 905 if the screenshots are determined as ones in a landscape mode according to the direction information; and proceed to Step 906 if the screenshots are determined as ones in a vertical mode according to the direction information.

In Step 905, the computer directly displays the screenshots in a display window.

In Step 906, the computer zooms in on the screenshots according to a length of the display window.

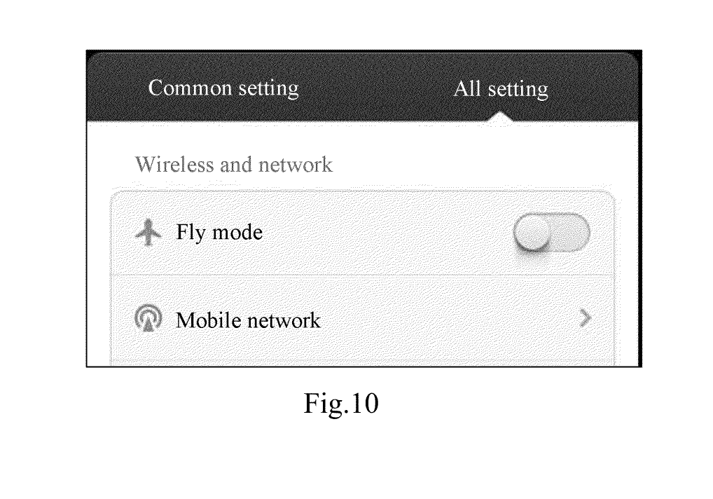

For example, the screenshots transmitted by the terminal device are as shown in FIG. 2, and screenshots zoomed in by the computer are as shown in FIG. 10. The screenshots zoomed in by the computer are much clearer.

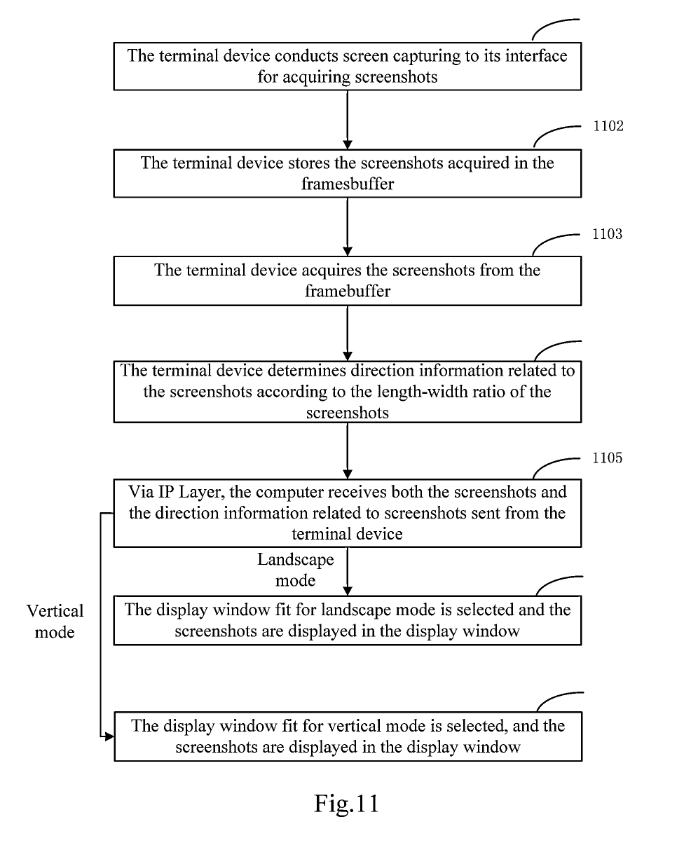

FIG. 11 is a flow chart showing a method for transmitting and receiving images according to another exemplary embodiment. As shown in FIG. 11, the method includes the following steps.

In Step 1101, a terminal device conducts screen capturing to its interface for acquiring screenshots.

In Step 1102, the terminal device stores the screenshots acquired in a framebuffer.

In Step 1103, the terminal device acquires the screenshots from the framebuffer.

In Step 1104, the terminal device determines direction information related to the screenshots according to a length-width ratio of the screenshots.

In Step 1105, via IP Layer, a computer receives both the screenshots and the direction information related to the screenshots sent from the terminal device. Proceed to Step 1105 if the screenshots are determined as ones in a landscape mode according to the direction information; and proceed to Step 1106 if the screenshots are determined as ones in a vertical mode according to the direction information.

In Step 1106, a display window fit for the landscape mode is selected and the screenshots are displayed in the display window. For example, a display window with a display scale of 16:9 is selected, and a size of the display window is adjusted according to the resolution of the screenshots.

In Step 1107, the display window fit for the vertical mode is selected, and the screenshots are displayed in the display window. For example, a display window with a display scale of 9:16 is selected, and the size of the display window is adjusted according to the resolution of the screenshots.

In the embodiment, the display scale of the display window may be adjusted to fit the screenshots. The display effect of the screenshots in screen capture of the terminal device is basically consistent with the display effect on the computer, with better display effect than that as shown in FIG. 3.

The implementation of transmitting the screenshots is referred to hereinabove, and the implementation is performed by the terminal device and the computer. The internal structure and function of the terminal device and the computer are introduced hereinafter.

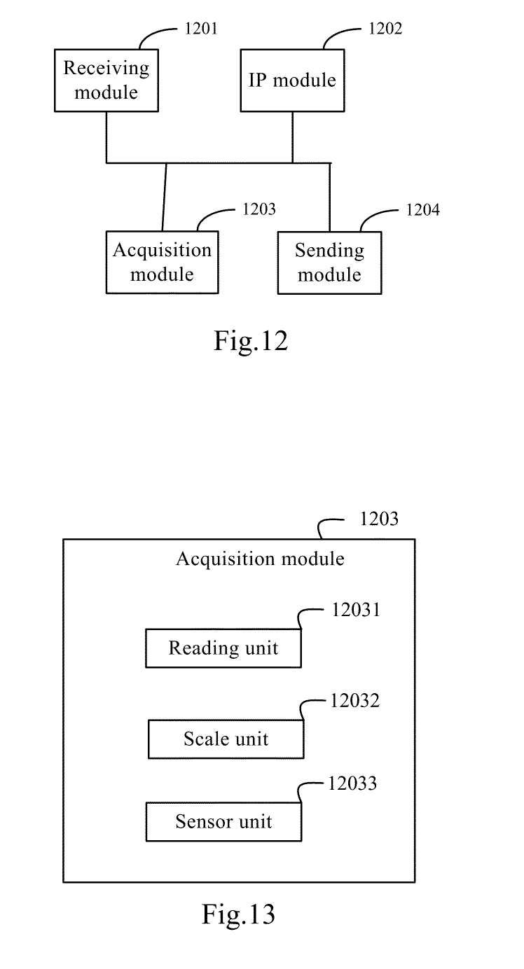

FIG. 12 is a schematic diagram of an apparatus for transmitting images according to an exemplary embodiment. Referring to FIG. 12, the apparatus includes: a receiving module 1201, an IP module 1202, an acquisition module 1203 and a sending module 1204. For example, the apparatus may be a terminal device.

The receiving module 1201 is configured to receive IP connection request sent from a computer.

The IP module 1202 is configured to acquire the IP address of the computer according to the received IP connection request.

The acquisition module 1203 is configured to acquire screenshots and direction information related to the screenshots.

The sending module 1204 is configured to send the screenshots and the direction information to the computer via IP Layer.

Optionally, referring to FIG. 13, the acquisition module 1203 includes: a reading unit 12031, a scale unit 12032 and a sensor unit 12033.

The reading unit 12031 is configured to read the direction information from a locally preset storage location for storing the direction information related to the screenshots.

The scale unit 12032 is configured to determine the direction information related to the screenshots according to a length-width ratio of the screenshots.

The sensor unit 12033 is configured to determine the direction information related to the screenshots according to the direction information determined by a local direction sensor.

Optionally, referring to FIG. 14, the apparatus also includes: a compression module 1205, configured to compress the screenshots and acquire the compressed screenshots. The sending module 1204 sends the compressed screenshots and the direction information to the computer via IP Layer.

Optionally, the IP connection request is a Real-time Transport Streaming Protocol (RTSP) session connection request based on IP Layer, and the RTSP session connection request includes a UDP port number for transmitting the screenshots. The sending module 1204 sends the screenshots and the direction information to the computer with the IP address and the UDP port number via the RTSP session of the IP Layer.

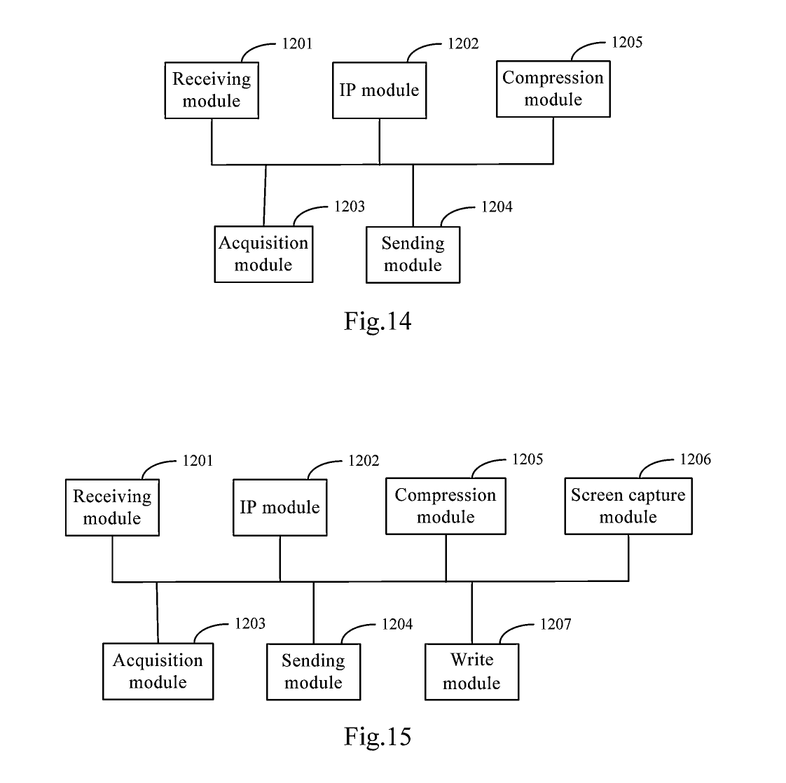

Optionally, referring to FIG. 15, the apparatus also includes: a screen capture module 1206 and a write module 1207. The screen capture module 1206 is configured to conduct screen capture of an interface of the terminal device for acquiring the screenshots. The write module 1207 is configured to store the screenshots acquired in a framebuffer. The acquisition module 1203 acquires the screenshots from the framebuffer.

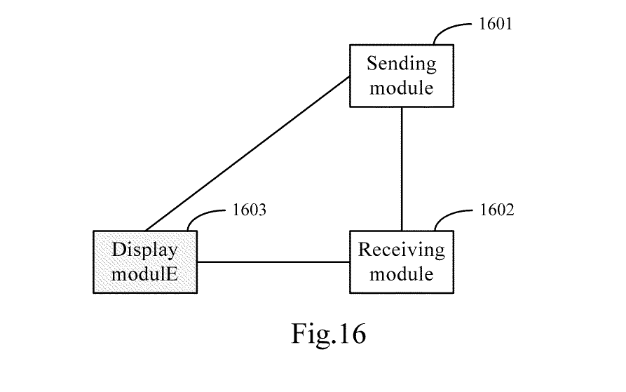

FIG. 16 is a schematic diagram of an apparatus for receiving images according to an exemplary embodiment. Referring to FIG. 16, the apparatus includes: a sending module 1601, a receiving module 1602 and a display module 1603. For example, the apparatus maybe a computer.

The sending module 1601 is configured to send IP connection request to a terminal device according to an IP address of the terminal device stored locally.

The receiving module 1602 is configured to receive both screenshots and direction information related to the screenshots sent from the terminal device via IP Layer.

The display module 1603 is configured to display the screenshots according to the direction information.

Optionally, the display module 1603 controls a scale and a size of a window for displaying the screenshots according to the direction information, and displays the screenshots by the window.

Optionally, the IP connection request is a Real-time Transport Streaming Protocol (RTSP) session connection request based on IP Layer, and the RTSP session connection request includes a UDP port number for transmission of the screenshots.

The sending module sends the screenshots and the direction information to the computer with the IP address and the UDP port number via the RTSP session of the IP Layer.

With regard to the apparatus in the above embodiment, detailed description of specific modes for executing operation of modules has been made in the embodiment of the method, no detailed illustration will be made herein.

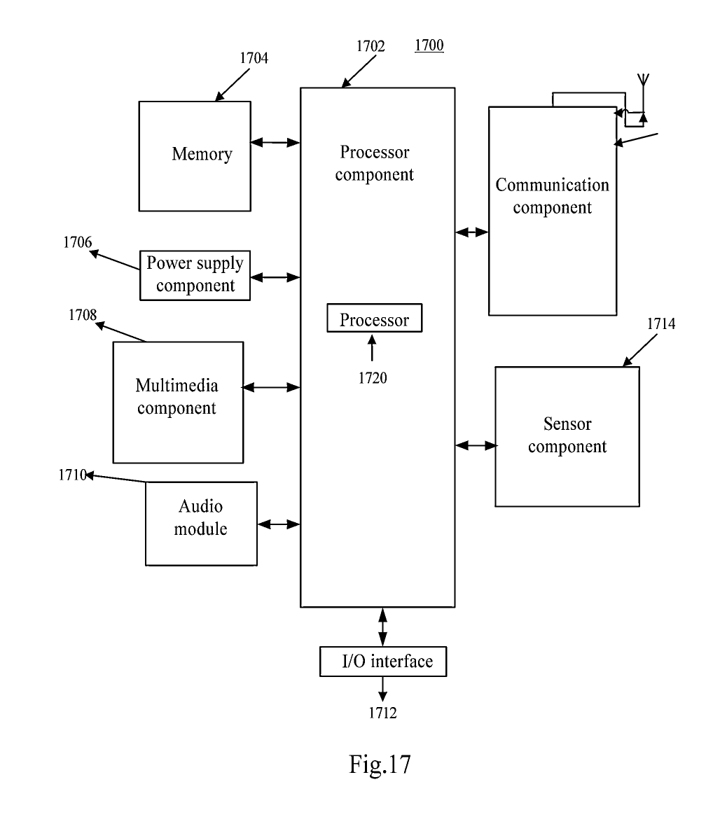

FIG. 17 is a block diagram of a device 1700 for transmitting images according to an exemplary embodiment. For example, the device 1700 may be a mobile telephone, a computer, a digital broadcasting terminal, a message transceiver device, a games console, a tablet device, a medical device, a fitness facility, a PDA (personal digital assistant) and the like.

Referring to FIG. 17, the device 1700 may include one or a plurality of components as below: a processor component 1702, a memory 1704, a power supply component 1706, a multimedia component 1708, an audio component 1710, an input/output (I/O) interface 1712, a sensor component 1714 and a communication component 1716.

The processor component 1702 usually controls the overall operation of the device 1700, for example, display, telephone call, data communication, and operation associated with camera operation and record operation. The processor component 1702 may include one or a plurality of processors 1720 for executing instructions so as to complete steps of above method in part or in whole. In addition, the processor component 1702 may include one or a plurality of modules for the convenience of interaction between the processor component 1702 and other components. For example, the processor component 1702 may include a multimedia module for the convenience of interaction between the multimedia component 1708 and the processor component 1702.

The memory 1704 is configured to store data of different types so as to support the operation of the device 1700. Examples of the data include any application program or approach directive for operation of the device 1700, including contact data, phonebook data, message, picture and video, etc. The memory 1704 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 1706 provides power for components of the device 1700. The power supply component 1706 may include a power management system, one or a plurality of power supplies, and other components associated with power generation, management and distribution of the device 1700.

The multimedia component 1708 includes a screen between the device 1700 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or a plurality of touch sensors for sensing gestures on the touch panel, for example, touching and sliding, etc. The touch sensor not only may sensor trip boundary of touching or sliding, but also may detect the duration and pressure related to the touching or sliding operation. In some embodiments, the multimedia component 1708 includes a front-facing camera and/or a rear-facing camera. When the device 1700 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 1710 is configured to output and/or input audio signal. For example, the audio component 1710 includes a microphone (MIC); when the device 1700 is under an operation mode such as call mode, record mode and speech recognition mode, the microphone is configured to receive external audio signal. The audio signal received may be further stored in the memory 1704 or sent out by the communication component 1716. In some embodiments, the audio component 1710 also includes a loudspeaker for outputting audio signal.

The I/O interface 1712 provides interface for the processor component 1702 and peripheral interface components, the peripheral interface components may be a keyboard, a click wheel and buttons, etc. These buttons may include but not limited to: home page button, volume button, start button and locking button.

The sensor component 1714 includes one or a plurality of sensors for providing the device 1700 with state evaluation from all aspects. For example, the sensor component 1714 may detect the on/off state of the device 1700, relative positioning of components, for example, the components are the displayer and keypads of the device 1700; the sensor component 1714 also may detect the position change of the device 1700 or a component thereof, the presence or absence of users' touch on the device 1700, the direction or acceleration/deceleration of the device 1700, and temperature variation of the device 1700. The sensor component 1714 may also include a proximity detector, which is configured to detect the presence of nearby objects in case of no physical touch. The sensor component 1714 may also include an optical sensor, for example, CMOS or CCD image sensor for imaging. In some embodiments, the sensor component 1714 may also include an acceleration sensor, a gyro sensor, a magnetic sensor, a pressure sensor, or a temperature sensor.

The communication component 1716 is configured for the convenience of wired communication or wired communication between the device 1700 and other equipment. The device 1700 is available for access to wireless network based on communication standards, for example, WiFi, 2G or 3G, or combination thereof. In an exemplary embodiment, the communication component 1716 receives via a broadcast channel the broadcast signal or broadcast-related information from external broadcast management systems. In an exemplary embodiment, the communication component 1716 also includes a near field communication (NFC) component for promoting short-range communication. For example, the NFC component may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the device 1700 may be realized by one or a plurality of application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the above methods.

In exemplary embodiments, a non-transitory computer-readable storage medium including instructions is also provided, for example, a memory 1704 including instructions, above instructions may be executed by the processors 1720 of the device 1700 so as to achieve the above methods. For example, the non-transitory computer-readable storage medium may be ROM, random access memory (RAM), CD-ROM, magnetic tape, floppy disk and optical data storage device, etc.

The device for transmitting images is provided, including: a processor; a memory configured to store instruction executable by the processor; wherein, the processor is configured to receive IP connection request sent from a computer, to acquire the IP address of the computer according to the received IP connection request, to acquire screenshots and direction information related to the screenshots, and to send the screenshots and the direction information to the computer via IP Layer according to the IP address.

The processor is configured to acquire the direction information related to the screenshots by reading the direction information from a locally preset storage location for storing direction information related to the screenshots, or by determining the direction information related to the screenshots according to a length-width ratio of the screenshots or by determining the direction information related to the screenshots according to direction information determined by a local direction sensor.

The processor also may be configured to compress the screenshots and acquire the compressed screenshots compressed; wherein sending the screenshots and the direction information to the computer via IP Layer comprises sending the compressed screenshots and the direction information to the computer via IP Layer.

The IP connection request is a Real-time Transport Streaming Protocol (RTSP) session connection request based on IP Layer, and the RTSP session connection request includes a UDP port number for transmission of the screenshots; wherein sending the screenshots and the direction information to the computer via IP Layer according to the IP address comprises sending the screenshots and the direction information to the computer with the IP address and the UDP port number via the RTSP session of the IP Layer.

A non-transitory computer-readable storage medium, wherein instructions in the storage medium are executed by the processor of the terminal device so that the terminal device may execute a method for transmitting images, and the method includes: receiving the IP connection request sent from the computer; acquiring the IP address of the computer according to the received IP connection request; acquiring the screenshots and the direction information related to the screenshots; and sending the screenshots and the direction information to the computer via IP Layer according to the IP address.

Instructions in the storage media may also include acquiring the direction information related to the screenshots by reading the direction information from a locally preset storage location for storing the direction information related to the screenshots, or by determining the direction information related to the screenshots according to the length-width ratio of the screenshots, or by determining the direction information related to the screenshots according to direction information determined by a local direction sensor.

Instructions in the storage media may also include compressing the screenshots and acquiring the compressed screenshots; wherein sending the screenshots and the direction information to the computer via IP Layer includes sending the compressed screenshots and the direction information to the computer via IP Layer.

The IP connection request is the Real-time Transport Streaming Protocol (RTSP) session connection request based on IP Layer, and the RTSP session connection request includes the UDP port number for transmission of the screenshots; wherein sending the screenshots and the direction information to the computer via IP Layer according to the IP address includes sending the screenshots and the direction information to the computer with the IP address and the UDP port number via the RTSP session of the IP Layer.

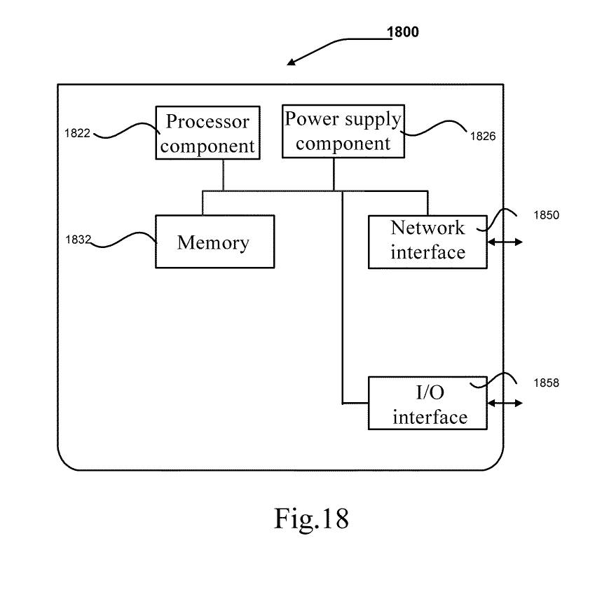

FIG. 18 is a block diagram of a device 1800 for receiving images according to an exemplary embodiment. For example, the device 1800 may be provided with a computer. Referring to FIG. 18, the device 1800 includes a processor component 1822, and further includes one or a plurality of processors, and memory resource represented by the memory 1832 and configured to store instructions executable by the processor component 1822, for example, application program. The application program stored in the memory 1832 may include one or a plurality of components each of which is corresponding to a set of instructions. In addition, the processor component 1822 is configured to execute instructions so as to execute image transmission according to the foregoing method.

The device 1800 may also include a power supply component 1826 configured to execute the power management of the device 1800, a wired or wireless network interface 1850 configured to connect the device 1800 to the network, and an input/output (I/O) interface 1858. The device 1800 may operate an operating system based on and stored in the memory 1832, for example, Windows Server™, Mac OS X™, Unix™, Linux™, FreeBSD™ or other similar operating systems.

The device for receiving images is provided, including: a processor; a memory configured to store instruction executable by the processor; wherein, the processor is configured to send IP connection request to a terminal device according to the IP address stored in the terminal device locally, to receive both the screenshots and the direction information related to the screenshots sent from the terminal device via IP Layer, and to display the screenshots according to the direction information.

The processor also may be configured to display the screenshots according to the direction information, including control a scale and a size of a window for displaying the screenshots according to the direction information, and display the screenshots by the window.

The IP connection request is an RTSP session connection request based on IP Layer, and the RTSP session connection request includes a UDP port number for transmission of the screenshots; wherein receiving both the screenshots and the direction information related to the screenshots sent from the terminal device via IP Layer, including receiving both the screenshots and the direction information related to the screenshots sent from the terminal device on the UDP port number via the RTSP session of IP Layer.

A non-transitory computer-readable storage medium, wherein instructions in the storage medium are executed by the processor of the terminal device so that the terminal device may execute a method for receiving images, and the method includes: sending the IP connection request to the terminal device according to the IP address stored in the terminal device locally; receiving both the screenshots and the direction information related to the screenshots sent from the terminal device via IP Layer; and displaying the screenshots according to the direction information.

Instructions in the storage media may also include displaying the screenshots according to the direction information, including controlling the scale and the size of a window for displaying the screenshots according to the direction information, and displaying the screenshots by the window.

The IP connection request is the RTSP session connection request based on IP Layer, and the RTSP session connection request includes the UDP port number for transmission of the screenshots; wherein receiving both the screenshots and the direction information related to the screenshots sent from the terminal device via IP Layer includes receiving both the screenshots and the direction information related to the screenshots sent from the terminal device on the UDP port number via the RTSP session of IP Layer.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for transmitting images, comprising:
receiving an IP connection request sent from a computer;
acquiring an IP address of the computer according to the received IP connection request;
acquiring screenshots and direction information related to the screenshots; and
sending the screenshots and the direction information to the computer via IP Layer according to the IP address.

2. The method of claim 1, wherein acquiring the direction information related to the screenshots comprises:
reading the direction information from a locally preset storage location for storing the direction information related to the screenshots.

3. The method of claim 1, wherein acquiring the direction information related to the screenshots comprises:
determining the direction information related to the screenshots according to a length-width ratio of the screenshots.

4. The method of claim 1, wherein acquiring the direction information related to the screenshots comprises:
determining the direction information related to the screenshots according to direction information determined by a local direction sensor.

5. The method of claim 1, wherein the method further comprises:
compressing the screenshots;
acquiring the compressed screenshots; and
sending the screenshots and the direction information to the computer via the IP Layer, wherein the compressed screenshots and the direction information is sent to the computer via the IP Layer.

6. The method of claim 1, wherein the IP connection request is a Real-time Transport Streaming Protocol (RTSP) session connection request based on the IP Layer, and the RTSP session connection request comprises a UDP port number for transmission of the screenshots.

7. The method of claim 1, wherein sending the screenshots and the direction information to the computer via the IP Layer according to the IP address comprises:
sending the screenshots and the direction information to the computer having the IP address and the UDP port number via the RTSP session of the IP Layer.

8. A method for receiving images, comprising:
sending an IP connection request to a terminal device according to an IP address of the terminal device stored locally;
receiving screenshots and direction information related to the screenshots sent from the terminal device via IP Layer; and
displaying the screenshots according to the direction information.

9. The method of claim 8, wherein displaying the screenshots according to the direction information comprises:
controlling a scale and a size of a window for displaying the screenshots according to the direction information; and
displaying the screenshots in the window.

10. The method of claim 8, wherein the IP connection request is an RTSP session connection request based on the IP Layer, and the RTSP session connection request comprises a UDP port number for transmission of the screenshots.

11. The method of claim 8, wherein receiving the screenshots and the direction information related to the screenshots sent from the terminal device via the IP Layer comprises:
receiving the screenshots and the direction information related to the screenshots sent from the terminal device on the UDP port number via the RTSP session of the IP Layer.

12. A device for transmitting images, comprising:
a processor;
a memory configured to store instruction executable by the processor; wherein the processor is configured to perform:
receiving an IP connection request sent from a computer;
acquiring an IP address of the computer according to the received IP connection request;
acquiring screenshots and direction information related to the screenshots; and
sending the screenshots and the direction information to the computer via IP Layer according to the IP address.

13. The device of claim 12, wherein acquiring the direction information related to the screenshots comprises:
reading the direction information from a locally preset storage location for storing the direction information related to the screenshots.

14. The device of claim 12, wherein acquiring the direction information related to the screenshots comprises:
determining the direction information related to the screenshots according to a length-width ratio of the screenshots.

15. The device of claim 12, wherein acquiring the direction information related to the screenshots comprises:
determining the direction information related to the screenshots according to direction information determined by a local direction sensor.

16. The device of claim 12, wherein the processor is further configured to perform:
compressing the screenshots;
acquiring the compressed screenshots; and
sending the screenshots and the direction information to the computer via the IP Layer, wherein the compressed screenshots and the direction information is sent to the computer via the IP Layer.

17. The device of claim 12, wherein the IP connection request is a Real-time Transport Streaming Protocol (RTSP) session connection request based on the IP Layer, and the RTSP session connection request comprises a UDP port number for transmission of the screenshots.

18. The device of claim 12, wherein sending the screenshots and the direction information to the computer via the IP Layer according to the IP address comprises:
sending the screenshots and the direction information to the computer having the IP address and the UDP port number via the RTSP session of the IP Layer.
